(19) United States
(12) Patent Application Publication
(10) Pub. No.: US 2003/0050394 A1
(43) Pub. Date: Mar. 13, 2003

(54) Oligomeric vinyl alcohol copolymers

(76) Inventors: Jorg Zimmermann, Lustenau (AT); Rolf Mulhaupt, Freiburg (DE)

Correspondence Address: BAYER CORPORATION, PATENT DEPARTMENT, 100 BAYER ROAD, PITTSBURGH, PA, 15205, US

(21) Appl. No.: 10/098,113

(22) Filed: Mar. 13, 2002

(30) Foreign Application Priority Data
Mar. 15, 2001 (DE) 10112365.5
May 4, 2001 (DE) 10121806.0

(51) Int. Cl. C08G 63/48

(52) U.S. Cl. 525/10

(57) ABSTRACT

The present invention relates to oligomeric copolymers of vinyl alcohol, vinyl esters and optionally, monomers that can be copolymerized with vinyl esters. The present invention also relates to processes for the production of these copolymers and to their used in the production of polyurethanes. Preferred oligomeric copolymers of the present invention include vinyl acetate/vinyl alcohol copolymers having a degree of polymerization of less than 30, and an OH-functionality of 1 to 15.

### BACKGROUND OF THE INVENTION

The present invention relates to oligomeric copolymers of vinyl alcohol, vinyl esters and, optionally, monomers that can be copolymerized with vinyl esters, to a process for the preparation of these vinyl alcohol copolymers, and to the preparation of polyurethanes from these vinyl alcohol copolymers. The present invention also relates to oligomeric vinyl acetate/vinyl alcohol copolymers, to a process for the preparation of vinyl acetate/vinyl alcohol copolymers, and to the preparation of polyurethanes from vinyl acetate/vinyl alcohol copolymers.

Liquid oligomers having hydroxyl groups are interesting polyols or polyol intermediates for polyurethane formulations. Polyols based on vinyl monomers, in particular on vinyl acetate, have hitherto been recognised only in isolated cases.

The preparation of α,ω-functionalized oligomeric methylmethacrylate diols by radical polymerization in the presence of 2-mercaptoethanol as a chain transfer agent is described in Macromol. Symp. 102 (1996) 91. The monofunctionalized oligomethylmethacrylates obtained during polymerization are converted into diols by selective transesterification of the terminal ester groups.

Known synthesis routes are not suitable for the preparation of liquid hydroxy-functionalized oligovinylacetate. Trials on the radical polymerization of vinyl acetate in the presence of different chain transfer agents (see Makromol. Chem. 44/46 (1961) 427) such as carbon tetrachloride (Kogyo Kagaku Zahsshi 64 (1961) 1691), alcohols (Kobunshi Kagaku 17 (1960) 120), alkyl halides (Kobunshi Kagaku 7 (1950) 269), aldehydes (Kobunshi Kagaku 12 (1955) 453) and thiols (Kogyo Kagaku Zahsshi 62 (1959) 1274), demonstrate poor control of the molecular weight, which is often associated with a large reduction in the rate of polymerization and monomer conversion. In all previous trials, products with a degree of polymerization of greater than 30 were obtained. The glass transition temperature of these products does not differ from that of high molecular weight polyvinyl acetate.

The partial hydrolysis of high molecular weight polyvinylacetate, e.g. by base-catalyzed hydrolysis or transesterification with methanol, is known. The high molecular weight polyvinylacetate/polyvinylalcohol copolymers obtained have very high viscosities and exhibit poor miscibility with other polyols. In addition, the proportion of vinyl alcohol content is more than 70%.

### SUMMARY OF THE PRESENT INVENTION

It has now been found that oligomeric vinyl ester (preferably vinyl acetate)/vinyl alcohol copolymers, and optionally, monomers that can be copolymerized with vinyl esters, with a low viscosity at room temperature, an accurately adjustable OH-functionality, a relatively low glass transition temperature, and good miscibility with other polyols can be obtained by radical polymerization using 2-propanol as a chain transfer agent followed by polymer-analogous reaction. These oligomers can be used in polyol components for polyurethane formulations.

The present invention relates to oligomeric copolymers of vinyl alcohols with vinyl esters, and optionally, monomers that can be copolymerized with vinyl esters, wherein the copolymers having a degree of polymerization of <30, preferably 2 to 15, and more preferably 6 to 12, and an OH functionality of 1 to 15, preferably 1 to 10, more preferably 2 to 8, and most preferably 2 to 6. In particular, the present invention also relates to oligomeric vinyl acetate/vinyl alcohol copolymers with a degree of polymerization of <30, preferably 2 to 15, and more preferably 6 to 12, and having an OH functionality of 1 to 15, preferably 1 to 10, more preferably 2 to 8, and most preferably 2 to 6.

The present invention also relates to a process for preparing these oligomeric copolymers of vinyl alcohols with vinyl esters, and optionally, monomers that can be copolymerized with vinyl esters, as described above. This process comprises 1) polymerizing vinyl ester monomers in the presence of an initiator and a chain transfer agent to yield a vinyl ester polymer having a degree of polymerization of <30, and 2) partially saponifying the vinyl ester polymer in the presence of an inert solvent and a base catalyst, with the addition of a defined amount of a solvolysis reagent, thus forming the vinyl alcohol/vinyl ester copolymer having the desired number of OH groups.

In addition, the present invention relates to a process for preparing the vinyl acetate/vinyl alcohol copolymers as described above. This process comprises 1) oligomerizing vinyl acetate in the presence of an initiator and a chain transfer agent in order to obtain a vinyl acetate oligomer with the desired degree of polymerization; and 2) partially saponifying the vinyl acetate oligomer in the presence of a base catalyst and an inert solvent, with the addition of a defined amount of a solvolysis reagent, thereby forming the vinyl acetate/vinyl alcohol copolymer having the desired number of OH groups.

### BRIEF DESCRIPTION OF THE FIGURES

FIG. 1a is a graph plotting the experimentally observed numbers of OH groups (ordinate) as obtained from the ¹H NMR spectra vs. the theoretically expected values (abscissa).

FIG. 1b is a graph plotting the experimentally observed numbers of OH groups (ordinate) as obtained from titration vs. the theoretically expected values (abscissa).

FIG. 2 is a graph of the DMA (dynamic mechanical analysis) curves, including the storage modulus (E′), the loss modulus (E″) and the loss tangent (tan δ), for Examples 16 and 17.

### DETAILED DESCRIPTION OF THE INVENTION

Oligomeric vinyl alcohol copolymers with vinyl ester, and optionally, with monomers that can be copolymerized with vinyl esters, wherein the copolymers have a degree of polymerization of less than (<) 30 and an OH functionality of 1 to 15 are one aspect of the present invention.

Oligomeric vinyl acetate/vinyl alcohol copolymers having a degree of polymerization of less than (<)30, and an OH functionality of 1 to 15 are another aspect of the present invention.

Carboxylates of vinyl alcohol are used as vinyl esters in the present invention. In addition to the preferably used vinyl acetate, other suitable carboxylates include, in particular, vinyl propionate or vinyl esters of long-chain carboxylic acids, e.g. vinyl stearate, vinyl laurate or vinyl esters of branched fatty acids, and also vinyl esters of maleic acid or fumaric acid. Vinyl esters of acrylic acid or methacrylic acid are also suitable for the present invention. In general, vinyl esters of long-chain or unsaturated carboxylic acids will be used in a mixture with vinyl acetate or vinyl propionate, since even small proportions of monomer units derived from vinyl esters of long-chain or unsaturated carboxylic acids are usually sufficient to modify the properties of the copolymer in the desired manner. If OH-functional copolymers produced in accordance with the present invention, containing monomer units derived from vinyl esters of long-chain fatty acids, are used in polyurethane formulations, they can act e.g. as internal plasticisers or mold release agents in the polyurethane.

Some examples of suitable monomers that can be copolymerised with vinyl esters include ethylene, vinyl chloride, crotonic acid, maleic anhydride, maleates such as dibutyl maleate and dioctyl maleate, and acrylates such as butyl acrylate or 2-ethylhexyl acrylate.

The present invention also relates to a process for the preparation of the oligomeric copolymers of vinyl alcohols with vinyl esters, and optionally, with other monomers which can be copolymerized with vinyl esters, wherein the copolymers have a degree of polymerization of less than (<)30, and an OH functionality of 1 to 15. This process comprises 1) polymerizing vinyl ester monomers in the presence of an initiator and a chain transfer agent to yield a vinyl ester polymer having a degree of polymerization of less than (<) 30, and 2) partially saponifying the vinyl ester polymer in the presence of an inert solvent and a base catalyst, with the addition of a defined amount of a solvolysis reagent, thus forming the vinyl alcohol/vinyl ester copolymer having the desired number of OH groups.

The present invention also relates to a process for the preparation of the vinyl acetate/vinyl alcohol copolymers having a degree of polymerization of less than 30, and an OH functionality of 1 to 15. This process comprises 1) oligomerizing vinyl acetate in the presence of a suitable initiator and a chain transfer agent, to yield a vinyl acetate oligomer having the desired degree of polymerization; and 2) partially saponifying the vinyl acetate oligomer in the presence of a base catalyst and an inert solvent, with the addition of a defined amount of solvolysis reagent, thereby forming the vinyl acetate/vinyl alcohol copolymer having the desired number of OH groups.

The oligomeric polyvinylacetates (PVAc's) formed in the first step of the process of the present invention are colorless, highly viscous liquids.

The degree of polymerization of the oligomeric polyvinylester and of the oligomeric polyvinylacetate obtained is determined by the ratio of monomer (i.e. vinyl ester or vinyl acetate) to chain transfer agent. If a large excess of chain transfer agent is used, the polyvinylester chain or the polyvinylacetate chain grows to be only a few monomer units long before it again enters into a transfer reaction and a new chain starts to grow. The actual excess required for the desired degree of polymerization can be determined easily by experiment.

Any commonly used initiators for free-radical polymerization are suitable, in principle, as initiators for the present invention including compounds such as, for example, dibenzoyl peroxide or 2,2′-azo-bis-isobutyronitrile (AIBN). Preferably, however, di-tert.-butyl peroxide (DTBP) is used as the initiator because the tert.-butanol being produced during initiation can easily be removed from the reaction mixture by distillation. The concentration of initiator required depends on the reaction temperature and the rate of decomposition of the initiator used. Concentrations of 0.5 to 4 mol. %, with respect to vinyl ester (or specifically to vinyl acetate), are generally suitable. The degree of polymerization of the oligomer is affected only slightly by the concentration of initiator.

Isopropanol is preferably used as the chain transfer agent, although other chain transfer agents can be used. Examples of other suitable compounds to be used as the chain transfer agent include alcohols such as isobutanol, aldehydes or ketones. The chain transfer agent also acts as a solvent. Excess chain transfer agent or excess solvent can easily be removed by distillation after the reaction.

A reaction temperature has to be chosen at which the rate of decomposition of the initiator is high enough to produce an adequate concentration of free radicals. The boiling point of the chain transfer agent or solvent chosen is often selected as the reaction temperature.

In the second step of the process, the vinyl ester oligomer, preferably the vinyl acetate oligomer, obtained is saponified in a targeted manner in order to produce a vinyl ester (preferably vinyl acetate)/vinyl alcohol copolymer having the desired number of OH-functional groups. Saponification is performed in the presence of an inert solvent, catalyzed by a base catalyst, and with the addition of a defined amount of a solvolysis reagent. Suitable solvolysis reagents include, for example, water and/or primary alcohols.

In the prior art, the saponification of polyvinylacetate has been mostly performed under basic conditions with the aid of an excess of water or alcohol, wherein the degree of saponification is controlled by the reaction time. A major problem of this method is that it leads to block copolymer structures of polyvinylacetate and polyvinylalcohol. This is discernible by the opaque appearance of the material which is caused by phase separation.

In order to inhibit this effect and in order to introduce only a few OH groups into the polymer, the saponification reaction of the polymer obtained in the first step is performed under controlled conditions, according to the present invention.

The saponfication reaction is performed in an inert solvent. Inert solvents are those which do not react or do not react to a significant extent with the vinyl ester oligomer or the vinyl acetate oligomer under the reaction conditions of the present invention and which are not deprotonated by the base used as catalyst. Examples of suitable inert solvents are aprotic solvents such as, for example, tetrahydrofuran (THF), although protic solvents, e.g. isopropanol, are also suitable, if they have a substantially lower acidity than the solvolysis reagent.

Any compounds which are suitable as solvolysis reagents are able to break the ester bond in vinyl ester units or vinyl acetate units. Water or primary alcohols are preferably used, and particularly, methanol. The amount of solvolysis reagent which is added depends on the number of OH groups intended to be present in the final product. It has been shown, when determining the functionality of the vinyl alcohol (preferably vinyl acetate/vinyl alcohol) copolymers obtained by terminal group titration, that when adding stoichiometric amounts of methanol as solvolysis reagent about 70% of the theoretically expected number of OH groups are formed. For example, when adding 2 moles of methanol (or solvolysis agent) per mole of polymer (or vinyl acetate oligomer), a vinyl alcohol (or vinyl acetate/vinyl alcohol) copolymer with on average 1.4 OH groups per molecule is obtained.

The reaction is performed in the presence of catalytic amounts of a base. Suitable bases include, for example, alcoholates such as potassium methylate.

If a uniform distribution of OH groups is intended to be achieved in the vinyl alcohol copolymers produced, it is advantageous to perform the saponification reaction at low reaction temperatures. The reaction temperature is preferably no higher than room temperature, and more preferably no higher than 0° C. Uniform distribution of the OH groups introduced along the polymer chain results in transparent products.

In a preferred embodiment of the invention, both steps of the process are performed as a one-pot reaction in 2-propanol as the solvent, wherein the 2-propanol also functions as the chain transfer agent in the first step. The vinyl ester polymer formed in the first step does not need to be isolated because the secondary products formed in the first step do not interfere with the subsequent saponification.

If the base is intended to be removed from the product after saponification, the reaction mixture is neutralized. This is advantageously achieved by passing the reaction mixture over an acid cation exchange resin.

The solvent can be removed by distillation after completing the reaction, or optionally, after the neutralization step.

The polyether polyols (i.e. vinyl ester/vinyl alcohol copolymers and vinyl acetate/vinyl alcohol copolymers) obtained by the process of the present invention are miscible with commercially available polyols, e.g. polyoxyalkylenepolyols, and may be used to prepare polyurethanes (e.g. elastomers, foams, coatings) by reaction with a polyisocyanate component. The mechanical properties of the polyurethanes prepared from the vinyl ester/vinyl alcohol copolymers and the vinyl acetate/vinyl alcohol copolymers of this invention are comparable to those of commercial polyurethanes.

### EXAMPLES

Vinyl acetate (VAc) was distilled immediately before use. THF (tetrahydrofuran) was dried over sodium, and 2-propanol (ⁱPrOH) was used without further purification. The potassium methylate solution used was prepared by reacting 2.45 g potassium with 250 ml methanol. The trifunctional propylene oxide/ethylene oxide block copolymer having a number average molecular weight of about 440 g/mol, which was used in Examples 16 and 17, was dried for 5 hours at 80° C. in a vacuum mixer.

Characterization of the Samples:

¹H NMR spectra were used to determine the molecular weight and to determine the terminal groups in the PVAc samples. Three different PVAc proton signals were seen in the spectra: between 1.6 and 2.0 ppm, the signals for methylene H-2 and for the methyl groups H-3, and between 5.0 and 5.2 ppm, the signals for the methyne group H-4. The two methyl groups in the 2-propanol-2-yl initiator H-1 produced a signal at 1.2 ppm. Assuming that initiation takes place via 2-propanol-2-yl radicals, all the PVAc chains have an isopropanol unit at the start of the chain. Given this presupposition, the number average degree of polymerization DPₙ, can be calculated from the ratios of the intensities of the signals from the monomer units (H-2, H-3, H-4; 6H) to the intensities of the signals from the initiator (H-1, 6H). In order to confirm the degree of polymerization and molecular weight determined from the ¹H NMR spectra, the molecular weight was also determined by vapor pressure osmosis (VPO).

¹H NMR spectra were obtained in d₅-pyridine using a Bruker ARX300 spectrometer. GPC measurements were performed in DMF at 45° C. VPO (vapor pressure osmosis) was measured in CHCl₃ using a Knauer vapor pressure osmometer K7000. DSC measurements were performed with Perkin Elmer DSC-7. The glass transition temperatures (T_{g}) were measured from the 2nd heating cycle at a heating rate of 10K/min. The measurements were performed in the temperature range from −100° C. to 120° C. Dynamic mechanical analysis (DMA) was performed in a Rheometrics solids analyzer RSAII at 1 Hz, and with a heating rate of 2K/min with “dual cantilever” geometry (50×4×2.5 mm) and an extension of 0.2%. The storage modulus (E′), the loss modulus (E″) and the loss tangent (tan δ) were measured in the temperature range 30° C. −100° C. For accurate determination of the glass transition temperature by DMA, each sample was measured 5 times, the maximum of the loss tangent was evaluated each time as T_{g}.

The number of OH groups was determined by titration and ¹H NMR. A mixture consisting of 0.45 l dry pyridine, 64.25 g phthalic anhydride and 10 ml N-methyl-imidazole was used as the esterification reagent for titration. Tertiary OH groups were not esterified in this reaction, and therefore, were also not detected. These groups also exhibit negligible reactivity towards isocyanates.

To determine the blank value V_{blank}, 25 ml of this esterification reagent was stirred for 15 min with 25 ml pyridine and 50 ml water, and then titrated with 1 N NaOH.

A polymer sample with the weight mₛₐₘₚₗₑ g was heated under reflux for 15 min with 25 ml of the esterification reagent. Then 25 ml pyridine and 50 ml water were added in order to hydrolyze the excess anhydride. Vₛₐₘₚₗₑ was obtained by titrating this solution with 1 N NaOH. Each polymer was measured twice. The number of OH groups per polymer (OHF) was then calculated from the following formula:

OHF=((V_{blank}−Vₛₐₘₚₗₑ)·Mₙ)/(1000·mₛₐₘₚₗₑ);

wherein:

Mₙ is the molecular weight of the polymer (as determined by VPO or ¹H NMR).

The number of OH groups per polymer chain (OHF) can be determined by comparing the ¹H NMR spectrum of the saponified sample with that of the PVAc initially used. Since the methyl group was removed with the acetate during methanolysis, the signal for the methyl group between 1.7 and 2.3 ppm (H-2, H-3) is also smaller. By comparing the ratio of signal intensities (H-2+H-3)/H-1 of the saponified sample with that of the PVAc initially used, the OHF can be calculated using the formula:

OHF=2·([(H-2+H-3)/H-1]_{substrate}−[(H-2+H-3)/H-1]_{product})

### Example 1

### PVAc6

A solution of 100 ml (1.08 mol) VAc in 1900 ml ⁱPrOH, corresponding to a monomer concentration of 4.2 mol. %, was introduced into a 4 l three-necked flask with a KPG stirrer and reflux condenser and degassed with nitrogen for 60 min. 2 ml (10.9 mmol) di-tert-butyl peroxide (DTBP) were added and the mixture was stirred for 18 h under reflux. The solvent was removed under vacuum and the polymer was dried for 60 min at 100° C. under vacuum on a rotary evaporator. 65 g PVAc6 were obtained as a colorless, highly viscous oil.

### Example 2

### PVAc10

Example 1 above was repeated, except that a (VAc in ⁱPrOH) monomer concentration of 8.3 mol. % was used.

### Example 3

### PVAc11

Example 1 above was repeated, except that a (VAc in ⁱPrOH) monomer concentration of 12.5 mol. % was used.

The samples prepared in Examples 1 to 3 were tested using ¹H NMR spectroscopy, vapor pressure osmosis (VPO), GPC and DSC. The results are set forth in Table 1.

TABLE 1

| | | ¹H NMR | | VPO^{a)} | | GPC^{b)} | | DSC |
|---|---|---|---|---|---|---|---|---|
| | [VAc]^{c)} | | Mₙ | | Mₙ | Mₙ | | T_{g} |
| Sample | [mol.%] | DPₙ | [g/mol] | DPₙ | [g/mol] | [g/mol] | M_{w}Mₙ | [K] |
| Example 1 | 4.2 | 6.2 | 590 | 6.4 | 610 | 18770 | 1.07 | 248 |
| (PVAc6) | | | | | | | | |
| Example 2 | 8.3 | 10.1 | 930 | 9.8 | 900 | 27390 | 1.07 | 276 |
| (PVAc10) | | | | | | | | |
| Example 3 | 12.5 | 11.5 | 1050 | 11.3 | 1030 | 33050 | 1.08 | 283 |
| (PVAc11) | | | | | | | | |

^{a)}measured in CHCl₃ at 40° C.
^{b)}measured in DMF (N,N-dimethylformamide) at 45° C. using a polystyrene standard
^{c)}molar ratio of VAc/(VAc + ⁱPrOH)

For VAc concentrations of about 4 to about 12 mol. % in 2-propanol, molecular weights between about 600 and about 1000 g/m were achieved. The molecular weight determined from ¹H NMR spectra agreed very well with that obtained from vapor pressure osmosis, which indicates that all the chains have a 2-propanol-2-yl group at one end and a hydrogen atom at the other end of the chain. The apparent molecular weight Mₙ from GPC correlates well with the molecular weight Mₙ determined by VPO. From the slope of the plotting Of Mₙ(GPC) against Mₙ(VPO), it can be seen that the molecular weight of oligomeric PVAc is roughly overestimated by a factor of 30 when using GPC.

### Example 4

### PVAc6/3

0.39 ml (9.6 mmol) of a 2% strength potassium methanolate solution were added to a solution of 2.0 g (3.2 mmol) PVAc6 in 40 ml dry THF. The mixture was stirred for 60 min at 0° C. and for a further 60 min at RT (room temperature). 3 g acid ion exchanger Amberlite® IR 120 (Fluka) were added to neutralize the reaction mixture and filtered off after 15 min.

The solvent was distilled off under reduced pressure and the polymer was dried under vacuum for 18 h at 60° C. PVAc6/3 was obtained as a highly viscous, colorless oil.

### Example 5

### PVAc6/1

Example 4 above was repeated, but only 0.13 ml (3.2 mmol) potassium methanolate solution were used.

### Example 6

### PVAc6/2

Example 4 above was repeated, but only 0.26 ml (6.4 mmol) potassium methanolate solution were used.

### Example 7

### PVAc10/2

In the same way as described in Example 4 above, PVAc10 was reacted with double the molar amount of potassium methanolate solution.

### Example 8

### PVAc10/4

In the same way as described in Example 4 above, PVAc10 was reacted with four times the molar amount of potassium methanolate solution.

### Example 9

### PVAc10/6

In the same way as described in Example 4 above, PVAc10 was reacted with six times the molar amount of potassium methanolate solution.

### Example 10

### PVAc11/2

In the same way as described in Example 4 above, PVAc 11 was reacted with double the molar amount of potassium methanolate solution.

### Example 11

### PVAc 1/4

In the same way as described in Example 4 above, PVAc 11 was reacted with four times the molar amount of potassium methanolate solution.

### Example 12

### PVAc 1/6

In the same way as described in Example 4 above, PVAc11 was reacted with six times the molar amount of potassium methanolate solution.

### Example 13

### PVAc6/3

0.39 ml (9.6 mmol) of a 2% strength potassium methanolate solution were added to a solution of 2.0 g (3.2 mmol) PVAc6 in 40 ml ⁱPrOH. The mixture was stirred for 60 min at 0° C. and for a further 60 min at RT. 3 g acid ion exchanger Amberlite® IR 120 (Fluka) were added to neutralize the reaction mixture and filtered off after 15 min. The solvent was distilled off under reduced pressure and the polymer was dried under vacuum for 18 h at 60° C.

### Example 14

### PVAc6/1

Example 13 above was repeated, but only 0.13 ml (3.2 mmol) potassium methanolate solution were used.

### Example 15

### PVAc6/2

Example 13 above was repeated, but only 0.26 ml (6.4 mmol) potassium methanolate solution were used.

In all cases, the samples obtained from Examples 4-15 were transparent, which indicated uniform distribution of the OH groups introduced along the polymer chain. The experimental data determined for the products prepared in Examples 4-15 are set forth in Table 2. The samples are called PVAcx/y, wherein x refers to the degree of polymerisation DPₙ of the PVAc used and y refers to the number of OH groups introduced per chain (without the tertiary OH groups at the start of the chain).

TABLE 2

| | Sample | | | | | |
|---|---|---|---|---|---|---|
| | Substrate | | | | | |
| | Mₙ | DPₙ | OHF^{a)} | | | DS^{b)} |
| | (VPO) | (VPO) | calculated | titration | ¹H NMR | [%] |
| Example 5 | 610 | 6.4 | 1 | 0.7 | 1.0 | 13.3 |
| (PVAc6/1) | | | | | | |
| Example 6 | | | 2 | 1.5 | 1.9 | 26.6 |
| (PVAc6/2) | | | | | | |
| Example 4 | | | 3 | 2.3 | 2.6 | 38.3 |
| (PVAc6/3) | | | | | | |
| Example 7 | 900 | 9.8 | 2 | 1.2 | 1.6 | 14.3 |
| (PVAc10/2) | | | | | | |
| Example 8 | | | 4 | 2.8 | 3.2 | 30.6 |
| (PVAc10/4) | | | | | | |
| Example 9 | | | 6 | 3.9 | 4.8 | 44.4 |
| (PVAc10/6) | | | | | | |
| Example 10 | 1030 | 11.3 | 2 | 1.4 | 1.8 | 14.2 |
| (PVAc11/2) | | | | | | |
| Example 11 | | | 4 | 3.0 | 3.3 | 27.9 |
| (PVAc11/4) | | | | | | |
| Example 12 | | | 6 | 4.3 | 4.6 | 39.4 |
| (PVAc11/6) | | | | | | |
| Example 14 | 610 | 6.4 | 1 | n.d.* | 0.85 | 13.3 |
| (PVAc6/1^{c)}) | | | | | | |
| Example 15 | | | 2 | n.d.* | 1.8 | 28.1 |
| (PVAc6/2^{c)}) | | | | | | |
| Example 13 | | | 3 | n.d.* | 2.8 | 43.8 |
| (PVAC6/3^{c)}) | | | | | | |

^{a)}average OH functionality per oligomer molecule (tertiary terminal group is not taken into account here)
^{b)}degree of saponification: [OH]/([OH] + [Ac])
^{c)}methanolysis in ⁱPrOH; Examples 13-15
*not determined

From Table 2, it is clear that in all cases the experimentally observed number of OH groups per molecule (OHF) is smaller than the value expected from stoichiometry. However, Table 2 shows that the degree of saponification is controlled only by the amount of methanol used. In all the samples in Table 2, the difference between the theoretically expected number and the actually introduced number of OH groups increases with increasing degree of saponification. For example, in the sample PVAc10/6 (i.e. Example 9 in Table 2), 6 OH groups are expected but only 4.8 groups are found in the ¹H NMR spectrum. However, the differences in degree of saponification found do not depend on the degree of polymerisation of the samples used. Thus, it is possible to predict the number of OH groups actually introduced by using a specific amount of methanol. Methanolysis is not affected by using ⁱPrOH instead of THF as an inert solvent. (Compare Examples 13, 14 and 15, with Examples 4, 5 and 6, respectively.) Because of the different pKa values of methanol and ⁱPrOH, only methanolysis is observed.

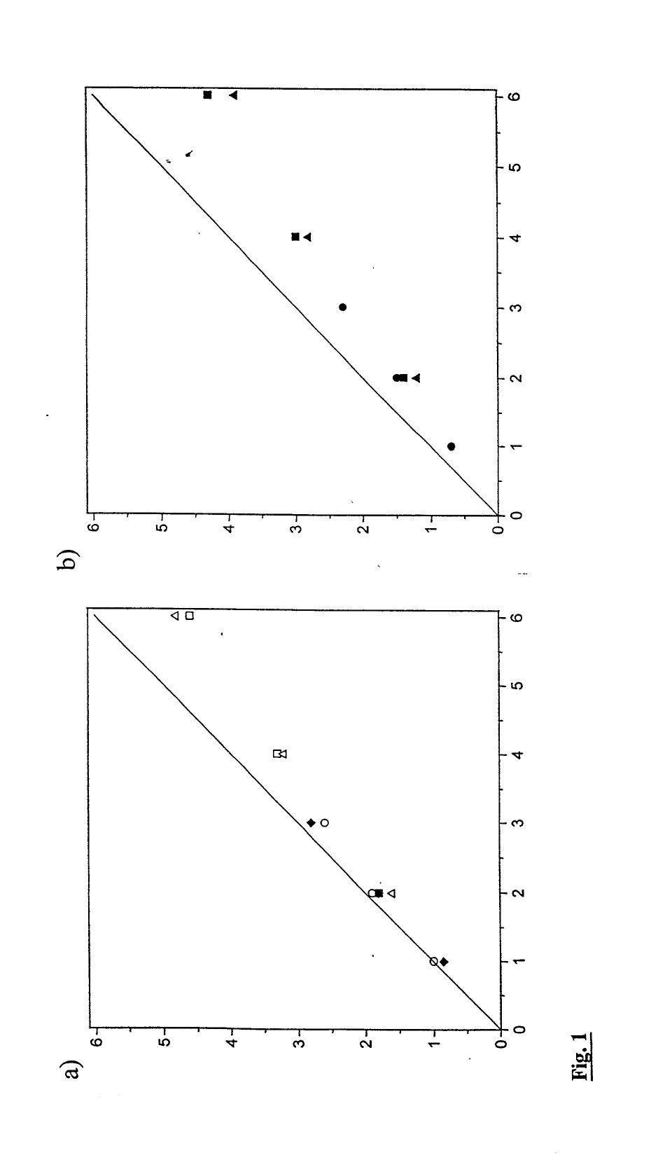

In FIG. 1, the experimentally observed numbers of OH groups (ordinate) were plotted against the theoretically expected values (abscissa). FIG. 1a gives the experimental data obtained from NMR spectra, and FIG. 1b gives the experimental data obtained from titration. Each diagonal corresponds to the values expected for complete (i.e. 100%) conversion.

### Example 16

### Synthesis of a Polyurethane Elastomer

50 g (82 mmol) PVAc6/3 and 50 g (114 mmol) of a trifunctional propylene oxide/ethylene oxide block copolymer with a number average molecular weight of 440 g/mol was dried for 2 h at 120° C. in a vacuum mixer under an oil vacuum. The homogeneous mixture was cooled to 30° C. and 68.4 g (274 mmol) methylenediphenylene diisocyanate (MDI) were dispersed in the polyol mixture. After stirring for 10 min, the transparent mixture was poured into a mold (200 mm×200 mm×4 mm), and cured for 12 h at 30° C., and for a further 24 h at 80° C.

### Example 17

### Comparison

Example 16 was repeated as described above, but the PVAc6/3 was replaced by an equimolar amount of a trifunctional propylene oxide/ethylene oxide block copolymer with a number average molecular weight of 440 g/mol.

The polyurethane sheets obtained in Examples 16 and 17 were yellow and transparent. The mechanical properties of the samples from Examples 16 and 17 are set forth in Table 3.

TABLE 3

| | | | | Glass |
|---|---|---|---|---|
| | Young's | Elongation at | | transition |
| | modulus | break | Hardness | temperature |
| Sample | [MPa] | [%] | [Shore D] | [° C.] |
| Example 17 | 2950 | 5.81 | 83 | 79.2 |
| (comparison) | | | | |
| Example 16 | 3490 | 2.94 | 85.7 | 81.5 |

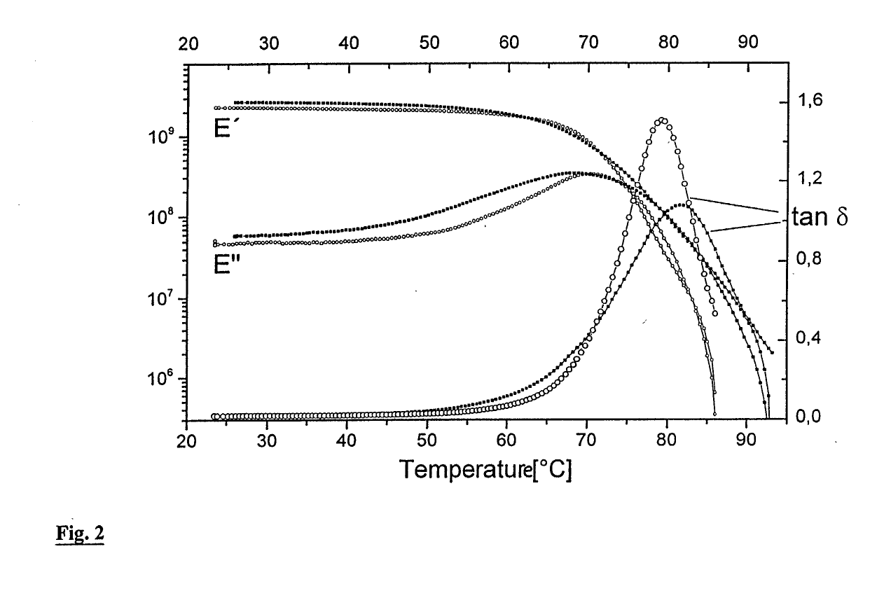

Young's modulus, a measure of the rigidity of the polymer, is larger for the polyurethane sample prepared using PVAc (i.e. Example 16). The glass transition temperature, determined using dynamic mechanical analysis (DMA), increases only slightly from 79.2° C. in Example 17 to 81.5° C. in Example 16. The DMA curves in FIG. 2 show that no phase separation takes place in the polyurethane (ex. 16: dark squares, ex. 17: open circles).

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A vinyl alcohol/vinyl ester copolymer having a degree of polymerization of <30 and an OH functionality of 1 to 15.

2. The copolymer of claim 1, additionally comprising one or more monomers that are copolymerizable with vinyl esters.

3. The copolymer of claim 1, wherein the OH functionality is from 1 to 10.

4. The copolymer of claim 1, wherein the degree of polymerization is 2 to 15 and the OH functionality is 2 to 8.

5. The copolymer of claim 1, wherein the degree of polymerization is 6 to 12 and the OH functionality is 2 to 6.

6. The copolymer of claim 1, wherein the vinyl ester comprises vinyl acetate.

7. A process for preparing a vinyl alcohol/vinyl ester copolymer having a degree of copolymerization of <30 and an OH functionality of 1 to 15, comprising:
1) polymerizing vinyl ester monomers in the presence of an initiator and a chain transfer agent to yield a vinyl ester polymer having a degree of polymerization of <30, and
2) partially saponifying the vinyl ester polymer in the presence an inert solvent and a base catalyst, with the addition of a defined amount of a solvolysis reagent.

8. The process of claim 7, wherein one or more monomers capable of copolymerization with vinyl ester monomers are polymerized the vinyl ester monomers in the presence of an initiator and a chain transfer agent to yield a vinyl ester/monomer copolymer having a degree of polymerization of <30, followed by partial saponification of the vinyl ester/monomer copolymer in the presence of an inert solvent and a base catalyst, with the addition of a defined amount of a solvolysis reagent.

9. The process of claim 7, wherein the initiator comprises di-tert.-butyl peroxide.

10. The process of claim 7, wherein the chain transfer agent comprises isopropanol.

11. The process of claim 7, wherein the base catalyst comprises potassium methylate.

12. The process of claim 7, wherein the inert solvent is selected from the group consisting of tetrahydrufuran and isopropanol.

13. The process of claim 7, wherein the solvolysis reagent is selected from the group consisting of water, primary alcohols and mixtures thereof.

14. The process of claim 7, wherein steps 1) and 2) are performed as a one-pot reaction, without isolation of the vinyl ester polymer formed in step 1).

15. The process of claim 7, wherein the vinyl ester comprises vinyl acetate.

16. The process of claim 15, wherein the vinyl ester oligomer formed in step 1) is a colorless, highly viscous liquid.

17. A process for the production of polyurethanes comprising reacting a polyisocyanate component with an isocyanate-reactive component comprising the vinyl alcohol/vinyl ester copolymers of claim 1.

18. A process for the production of polyurethanes comprising reacting a polyisocyanate component with an isocyanate-reactive component comprising the vinyl acetate/vinyl alcohol copolymers of claim 6.

19. The polyurethanes produced by the process of claim 17.

20. The polyurethanes produced by the process of claim 18.
